(19) United States
(12) Patent Application Publication
(10) Pub. No.: US 2002/0158202 A1
(43) Pub. Date: Oct. 31, 2002

(54) Laser-based sensor for measuring combustion parameters

(76) Inventors: Michael E. Webber, Culver City, CA (US); Ronald K. Hanson, Cupertino, CA (US); Scott T. Sanders, Madison, WI (US)

Correspondence Address: Marek Alboszta, Lumen, 45 Cabot Ave., Suite 110, Santa Clara, CA, 95051, US

(21) Appl. No.: 10/042,772

(22) Filed: Jan. 8, 2002

Related U.S. Application Data
(60) Provisional application No. 60/260,535, filed on Jan. 8, 2001.

(51) Int. Cl. G01J 5/02; F23N 5/00

(52) U.S. Cl. 250/339.13; 431/75

(57) ABSTRACT

The present invention provides a laser-based method and apparatus that uses absorption spectroscopy to detect the mole fraction of CO₂ in a high temperature gas stream. In a preferred embodiment, a distributed feedback based diode laser sensor operating at a wavelength near 1996.89 nm (5007.787 cm⁻¹) interrogates the R(50) transition of the ν₁+2ν₂+ν₃ CO₂ absorption band in the near infrared. This transition is specifically chosen based on its superior linestrength and substantial isolation from interfering absorption by high-temperature H₂O, CO, NH₃, N₂O, NO, and other species commonly present in combustion or other high-temperature gas flows.

### CROSS-REFERENCES TO RELATED APPLICATIONS

This application claims the benefit of U.S. Provisional Application No. 60/260,535, filed on Jan. 8, 2001, which is hereby incorporated herein by reference in its entirety.

### STATEMENT REGARDING FEDERALLY SPONSORED RESEARCH OR DEVELOPMENT

This invention was supported in part by grant number R827123-01-0 from the Environmental Protection Agency (EPA) and by the Air Force Office of Scientific Research (AFOSR). The U.S. Government has certain rights in the invention.

### BACKGROUND OF THE INVENTION

1. Field of the Invention

This invention relates generally to methods and devices for measuring gas-phase concentrations of chemical species. More particularly, it relates to a laser-based sensor for measuring concentration of carbon dioxide (CO₂) in high-temperature (>400 K) gas flows that contain water vapor.

2. Description of the Related Art

Carbon dioxide is a major product of combustion and thus an indicator of combustion efficiency. For applications such as waste incinerators where the fuel content varies, continuous real-time measurements of CO₂ during lean operation can be used to measure total carbon in the post-combustion products for environmental regulations compliance monitoring and combustion control applications. Many industrial applications require or benefit from measurement of CO₂ concentrations in high-temperature gas flows.

Utilizing absorption spectroscopy techniques, accurate values of CO₂ mole fraction can be determined from absorption measurements, provided that reliable values of fundamental spectroscopic parameters, i.e., line strengths, line positions, line-broadening parameters, lower-state energy levels of the probed transitions, and the molecular partition function, are known.

However, as is well known in the art, reliable fundamental spectroscopic parameters are extremely difficult to obtain. High-temperature H₂O vapor interference, for example, is a common problem for optical techniques that seek to measure a target species such as CO₂ in combustion systems or other flows in which H₂O is present in significant quantities.

Also, prior art combustion control methodologies seeking to maximize CO₂ while minimizing CO relied on relatively slow sensors and thus were unable to implement control at rates faster than 2 Hz. For example, prior art absorption sensors for CO₂ combustion monitoring include diagnostics using relatively weak overtone bands near 1.55 μm, and initial measurements near 2.0 μm utilizing external-cavity diode lasers (ECDL). The measurements near 1.55 μm suffered from weak signal strengths and significant interference from high-temperature water absorption. The latter body of work benefited from CO₂ 's strong absorption at 2.0 μm, but was restricted to slow scan rates (<25 Hz repetition) due to the ECDL's mechanical operation, and could not access all the isolated CO₂ lines in the band. What is more, most previous measurements had to use sampling techniques and could not measure CO₂ concentration in situ.

At least for the aforementioned reasons, there is a continuing need in the art for a reliable non-intrusive laser-based method and apparatus that utilizes absorption spectroscopy and particularly CO₂'s strong absorption band at 2.0 μm to fast and accurately detect and measure carbon dioxide concentrations in a high temperature gas stream containing water vapor.

### BRIEF SUMMARY OF THE INVENTION

It is therefore a general object of the present invention to provide a laser-based sensor system that utilizes absorption spectroscopy to detect and measure the mole fraction of carbon dioxide (CO₂) in a high temperature gas stream containing water vapor (H₂O), in a non-intrusive, accurate, reliable, and speedy manner.

It is a particular object of the present invention to provide a method for non-intrusively measuring CO₂ concentration in a high temperature gas flow containing H₂O, the method including operating a laser sensor at a selective wavelength substantially near 2 μm to spectrally interrogate a selective R(50) spectroscopic transition of the ν₁+2ν₂+ν₃ CO₂ absorption band in near-infrared for sensitive measurements of CO₂, wherein the R(50) spectroscopic transition is selected because of its substantial isolation from interfering absorption by high temperature species including H₂O present in the high temperature gas flow.

It is another object of the present invention to provide a laser-based sensor system having a plurality of multiplexed laser sensors operating at a plurality of selective wavelengths for non-intrusively and simultaneously measuring combustion parameters including CO₂ along a single optical path in a high temperature gas flow containing H₂O, wherein the improvement comprising one of the laser sensors operates at a selective wavelength substantially near 2 μm for spectral interrogation of a selective R(50) spectroscopic transition of the ν₁+2ν₂+ν₃ CO₂ absorption band in near-infrared for sensitive measurements of CO₂, wherein the R(50) spectroscopic transition is selected based on its linestrength and isolation from interfering absorption by high temperature species including H₂O present in the high temperature gas flow.

It is yet another object of the present invention to provide for combustion applications an on-line in situ CO₂ diagnostic tool based on diode laser absorption techniques wherein the on-line in situ CO₂ sensor permits concentration measurements at much higher repetition rates, enables faster control implementation, and can be used with CO, H₂O and gas temperature sensors as part of a comprehensive combustion control tool to maximize CO₂, H₂O and temperature while minimizing CO.

It is a further object of the present invention to provide a fiber-coupled distributed feedback diode laser sensor that operates at a selective wavelength near 1996.89 nm (5007.787 cm⁻¹) for spectral interrogation of the R(50) transition of the ν₁+2ν₂+ν₃ CO₂ absorption band in the near infrared. This transition is chosen specifically because of its linestrength and isolation from interfering absorption by high-temperature H₂O, CO, NH₃, N₂O, NO, and other species typically present in combustion or other high-temperature flows.

Still further objects and advantages of the present invention will become apparent to one of ordinary skill in the art upon reading and understanding the following drawings and detailed description discussed herein. As it will be appreciated by one of ordinary skill in the art, the present invention may take various forms and may comprise various components, steps and arrangements thereof. Accordingly, the drawings are for purposes of illustrating principles and embodiments of the present invention and are not to be construed as limiting the present invention.

### BRIEF DESCRIPTION OF THE DRAWINGS

FIG. 1 shows how the linestrengths for CO₂ and H₂O vary with wavelength throughout the near-infrared spectrum. By using a laser-based sensor operating near 2 μm in wavelength instead of at 1.55 μm, much stronger absorption bands of CO₂ can be interrogated.

FIG. 2 shows calculated spectra of 10% CO₂ and 10% H₂O near 1.997 μm at combustion conditions.

FIG. 3 is a schematic for measuring absorption spectra of CO₂ at a range of pressures and temperatures using a DFB operating at near 2 μm.

FIG. 4 shows absorbance of pure CO₂ for various pressures near 5008 cm⁻¹.

FIG. 5 shows a sample lineshape for static cell measurements of CO₂ absorbance at 5007.787 cm⁻¹.

FIG. 6 is a graph showing linestrength versus temperature for the R(50) transition at 5007.787 cm⁻¹.

FIG. 7 is a schematic showing an embodiment of the present invention for the in situ combustion measurements.

FIG. 8 is a graph showing sample CO₂ lineshape for absorption measurements in the combustion region using the R(50) transition.

### DETAILED DESCRIPTION OF THE INVENTION

Based on absorption of the wavelength-tuned laser intensity as the beam propagates across a measuring path, diode lasers first found application to in situ measurements of combustion gases in the research and development environments in the 1970's. In situ absorption spectroscopy methods are desirable because they advantageously yield path-averaged species concentration measurements without intrusive probes that can perturb the flow or combustion environment and avoid the inherent time lag due to gas transport associated with extractive-sampling methods, thereby permitting rapid measurements at kHz rates and higher.

Recently, near infrared (NIR) diode lasers have been used to measure species concentrations in combustion environments. NIR diode laser sensors are attractive for real combustion systems due to their compact and robust nature, reasonable cost, ease of temperature control, i.e., near room temperature operation, and compatibility with standard telecommunications-grade optical fiber components. For an overview on recent development of NIR diode laser absorption sensors, as well as other gas dynamic and combustion flow sensors based on laser absorption spectroscopy, readers are referred to Mark G. Allen's “Diode laser absorption sensors for gas dynamic and combustion flows”, 1998, which is hereby incorporated by reference.

Amongst species concentrations in combustion environments, carbon dioxide is of interest because it is an indicator of combustion efficiency and a major greenhouse gas that might be subjected to stringent environmental regulations. For applications such as waste incinerators where the fuel content varies, continuous measurements of CO₂ during lean operation can be used to measure total carbon in the post-combustion products for compliance monitoring and control applications.

As is well known in the art, commercial applications of a diode laser absorption sensor system depend on many variables such as cost, size, performance, operational complexities, device reliability, as well as diode laser materials. The maturity of and advancement in related technologies, such as fabrication processes and antireflection (AR) coating technology, may also affect the purity and hence the quality of the measurements obtained by the diode laser absorption sensor and the lifetime of the sensor itself.

More importantly, many commercial combustors operates at atmospheric pressure or higher and at temperatures above 1500 K. In addition to the aforementioned diode laser sensor system design considerations, developing a NIR diode laser CO₂ absorption sensor for these combustors thus requires a thorough understanding of the effects of temperature and pressure on absorption spectra. That is, the performance of such NIR diode laser absorption sensor is dependent upon accurate measurements of fundamental spectroscopic parameters, including linestrength, lower-state energy, and broadening coefficients.

As mentioned heretofore, reliable and accurate —45 measurements of these fundamental spectroscopic parameters are difficult to obtain due to problems such as high temperature water absorption interferences. Thus, using a laser wavelength that overlaps with a spectroscopic transition of the target species and is simultaneously isolated from H₂O interference and strong enough to be measured is the key to successful monitoring. However, though several diode laser based absorption sensors have been developed in research laboratories, affordable sensors that can measure absolute CO₂ concentrations non-intrusively in combustion environments are not yet available to-date. Exemplary teachings on absorption sensors employing different approaches, including using relatively weak overtone band near 1.55 μm and initial measurements near 2.0 μm utilizing external-cavity diode lasers (ECDL), can be found in the following publications, which are all hereby incorporated herein by reference:

1. R. K. Hanson et al. “High-resolution Spectroscopy of Combustion Gases Using a Tunable IR Diode Laser”, 1977.

2. R. K. Hanson “Combustion Diagnostics: Planar Imaging Techniques”, 1986.

3. U.S. Pat. No. 5,178,002, titled “Spectroscopy-based thrust sensor for high-speed gaseous flows”, issued to R. K. Hanson and assigned to the Board of Trustees of the Leland Stanford Jr. University, California.

4. R. K. Hanson “Recent Advances in Laser-based Combustion Diagnostics”, 1997.

5. D. M. Sonnenfroh et al. “Observation of CO and CO₂ absorption near 1.57 μm with an external-cavity diode —45 laser”, 1997.

6. R. M. Mihalcea et al. “Diode-Laser Sensor for Measurements of CO, CO₂, and CH₄ in Combustion Flows”, 1997.

7. R. M. Mihalcea et al. “Diode-Laser Absorption Sensor for Combustion Emission Measurements”, 1998.

8. R. M. Mihalcea, et al. “Advanced Diode Laser Absorption Sensor for in-situ Combustion Measurements of CO₂, H₂O, and Gas Temperature”, 1998.

9. R. M. Mihalcea, et al. “Diode-Laser Absorption Measurements CO₂, H₂O, N₂O, and NH₃ near 2.0 μm”, 1998, wherein a diode-laser sensor was developed for sensitive measurements of CO₂, H₂O, N₂O, and NH₃ concentrations in various flowfields using absorption spectroscopy and extractive sampling techniques. An ECDL having a wavelength tuning range of 1.953-2.057 μm (4861 cm⁻¹-5118 cm⁻¹) was used for a single-sweep measurement of the P(16) absorption line in the CO₂ ν₁+2ν₂⁰+ν₃ band recorded in a multipass cell containing sampled room air.

10. R. M. Mihalcea, et al. “Diode-Laser Measurements of CO₂ near 2.0 μm at Elevated Temperatures”, 1998, wherein a diode-laser sensor system consisted of an ECDL having a wavelength tuning range of 1.953-2.057 μm (4860 cm⁻¹-5120 cm-1) was developed for nonintrusive measurements of CO₂ in high-temperature environments. Fundamental spectroscopic parameters including the line strength, the self-broadening coefficient, and the temperature dependence of the broadening coefficient of the CO₂ R(56) transition (20012←00001 band) were determined for temperatures between 296 and 1500K. Additional potential CO₂ transitions for in situ detection at elevated temperatures were speculated to be the R(38) line at 5002.487 cm⁻¹ or the R(50) line at 5007.787 cm⁻¹.

As is well known in the art, commercially available ECDL's generally construct a Littman cavity between the rear facet of the diode, a tunable grating, and a high reflectivity mirror. Accordingly, operational details of the ECDL are sensitive to the construction of the cavity and the reflectance properties of the surfaces within it. The tuning performance of the laser, on the other hand, is critically dependent on the quality of the anti-reflective (AR) coating on the front facet of the diode, as pointed out by D. M. Sonnenfroh et al. in reference 5. Weak reflectance from the front facet can setup a second set of cavity modes leading to mode-hops in the tuning range or coupled frequency, polarization and amplitude modulation of the output with tuning. The ECDL's are physically much larger than simple current- and temperature-tuned devices and require mechanical motion to operate, limiting their use to mostly research and laboratory environments. Further, due to this mechanical operation, a diode laser absorption sensor system consisting of an ECDL thus is restricted to slow scan rates (<25 Hz repetition) and could not access all the isolated CO₂ lines in the band.

Utilizing the recently available distributed feedback (DFB) diode lasers operating near 2.0 μm, the present invention provides an improved laser-based absorption sensor system and method for measuring gas-phase concentration of CO₂ in high-temperature flows (>400 K) containing water vapor. DFB diode lasers offer the advantages of high bandwidth (up to kHz repetition rates), ruggedness, compactness, and affordability, while the longer wavelengths that have become available in recent years offer access to CO₂'s strong absorption band near 2.0 μm.

It will become apparent to one of ordinary skill in the art that the present invention may be embodied in various forms, some of which are described in our following publications, which are all hereby incorporated by reference.

Michael E. Webber et al., “In situ Combustion Measurements of CO₂ Using Diode Laser Sensors Near 2.0 μm,” 38^{th} American Institute of Aeronautics and Astronautics Aerospace Sciences Meeting and Exhibit, Reno, Nev., Jan. 10-13, 2000, AIAA Paper 2000-0775.

Michael E. Webber et al., “In situ Combustion Measurements of CO, CO₂, H₂O and Temperature Using Diode Laser Absorption Sensors,” Proceedings of the 28^{th} International Symposium on Combustion, The Combustion Institute, Pittsburgh, Pa., 2000.

Michael E. Webber et al., “In situ Combustion Measurements of CO₂ Using a Distributed Feedback Diode Laser Sensor Near 2.0 μm,” Applied Optics, February 2001.

Preferred embodiments according to the principles of the present invention will now be described with reference to the drawings disclosed herein.

Theory

The fundamental theory governing absorption spectroscopy for narrow linewidth radiation sources is embodied in the Beer-Lambert law, Equation 1, and is described thoroughly in “Tunable diode-laser absorption measurements of methane at elevated temperatures”, 1996, by V. Nagali et al., which is hereby incorporated herein by reference. In brief, the ratio of the transmitted intensity Iₜ and initial (reference) intensity I₀ of laser radiation through an absorbing medium at a particular frequency is exponentially related to the transition linestrength Sᵢ [cm⁻²atm⁻¹], lineshape function φ [cm], total pressure P [atm], mole fraction of the absorbing species xⱼ, and the pathlength L [cm], such that

$$\frac{{I}_{t}}{{I}_{0}} = exp ( - {S}_{i} φ {Px}_{j} L ) . \qquad ( 1 )$$

The normalized lineshape function describes the effects of thermal motion (Doppler broadening) and intermolecular collisions (collisional or pressure broadening). The collision width, Δν_{c}, is the absorption line's full-width at half-maximum (FWHM) resulting from collisions, and at a given temperature is directly proportional to pressure:

$$Δ {v}_{C} = P {\sum }_{B} {X}_{B} {2}_{{γ}_{A - B}} . \qquad ( 2 )$$

In Equation 2, A is the species of interest, P is the total pressure, X_{B} is the mole fraction of the B^{th} perturber, and γ_{A-B} is the broadening coefficient for A's transitions by that perturber. For self-broadening, the coefficient is often denoted γ_{A-A} or γ_{self}. The broadening coefficient's temperature variation is often modeled according to the following expression:

$${2}_{γ} ( T ) = {2}_{γ} ( {T}_{0} ) {( \frac{{T}_{0}}{T} )}^{N} \qquad ( 3 )$$

where T₀ is a reference temperature, 2γ(T₀) is the broadening coefficient at the reference temperature, and N is the temperature exponent. The thermal or Doppler width, Δν_{D}, is

$$Δ {v}_{D} = 7.1623 \times {10}^{- 7} {v}_{0 , i} \sqrt{\frac{T}{M}} , \qquad ( 4 )$$

where ν_{0,i} is the frequency of the transition and M is the mass of the molecule in atomic mass units. For atmospheric pressure, the lineshape is a convolution of the Doppler and collisional distributions, yielding a Voigt profile. The Voigt profile is governed by the Voigt α parameter, which relates the thermal and collisional widths with α increasing as the lineshape becomes more collisionally-broadened, such that

$$a = \frac{\sqrt{ln 2} Δ {v}_{C}}{Δ {v}_{D}} . \qquad ( 5 )$$

The linestrength as a function of temperature for a particular CO₂ transition i is goverened by its linestrength Sᵢ at a reference temperature To; the partition function Q(T) of CO₂; the frequency of the transition, ν_{0,i}; and the lower-state energy of the transition, Eᵢ″. This relationship is given by:

$${S}_{i} ( T ) = {S}_{i} ( {T}_{0} ) \frac{Q ( {T}_{0} )}{Q ( T )} ( \frac{{T}_{0}}{T} ) exp [ - \frac{{hcE}_{i}^{″}}{k} ( \frac{1}{T} - \frac{1}{{T}_{0}} ) ] \times {[ 1 - exp ( \frac{- {hcv}_{0 , i}}{kT} ) ] [ 1 - exp ( \frac{- {hcv}_{0 , i}}{{kT}_{0}} ) ]}^{- 1} . \qquad ( 6 )$$

Line Selection

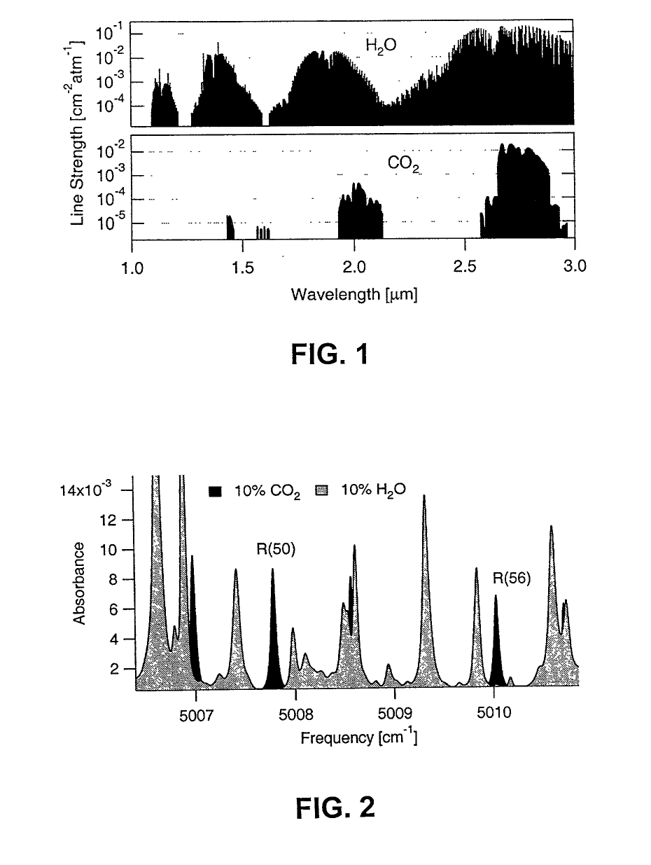

FIG. 1 graphically depicts the near-infrared (NIR) linestrengths of carbon dioxide and water over a range of wavelengths from 1 to 3 μm at a temperature of 1500 K. As disclosed by L. S. Rothman et al. in “The HITRAN molecular spectroscopic database and HAWKS (HITRAN atmospheric workstation): 1996 edition,” 1998, referred to as “HITRAN96” hereinafter, CO₂ has absorption bands near 1.5, 2.0 and 2.7 μm. The absorption bands near 1.55 μm overlap conveniently with commercially available telecommunications diode lasers and thus were commonly used for measurements of CO₂. However, as can be seen in FIG. 1, sensors at 2.0 μm can access linestrengths that are approximately two orders of magnitude larger than at 1.55 μm. Thus, diagnostics that employ these longer wavelengths offer greater sensitivity.

According to an aspect of the present invention, calculated absorption spectra based on the HITRA96 database near 2.0 μm have been compared for combustion conditions (T=1500 K, 10% H₂O, 10% CO₂, balance air, P=1 atm, L=10 cm) and used to find isolated CO₂ transitions. As can be seen in FIG. 2, both the R(56) and R(50) transitions of the ν₁+2ν₂+ν₃ CO₂ band at 5007.787 and 5010.035 cm⁻¹, respectively, are isolated from high temperature water interference and thus are candidate lines for use with a diode laser absorption sensor. Previous measurements of CO₂ near 2.0 μm, such as one disclosed by R. M. Mihalcea et al. in “Diode-Laser Measurements of CO₂ near 2.0 μm at Elevated Temperatures” (reference 10), employed a research grade ECDL and thus were restricted to interrogating the R(56) line at 5010.035 cm⁻¹ for combustion monitoring. That is, given the restrictive nature of the ECDL and the particular set up of the sensor system, it would be unduly difficult to implement other CO₂ transition lines, even though other potential CO₂ transitions were speculated. What is more, the R(56) transition's absorption records are affected by non-negligible spectral interference from neighboring high-temperature H₂O lines and require complicated 7-line Voigt fits to extract the partial pressure of CO₂.

Measuring Absorption Spectra of CO₂

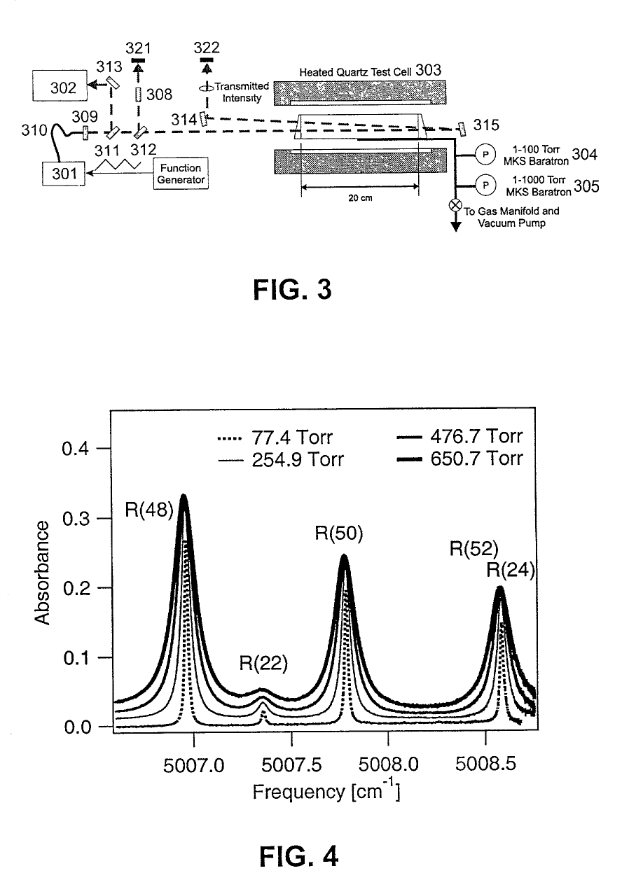

FIG. 3 shows a basic setup for measuring absorption spectra of CO₂ at a range of pressures and temperatures. The diode laser system of FIG. 3 comprises a fiber-pigtailed distributed feedback (DFB) diode laser 301 operating near 1.997 μm, quartz beam splitters 311, 312, mirrors 313, 314, 315, and extended wavelength response InGaAs detectors 321, 322 for monitoring the laser intensity. The DFB laser 301 is tuned in wavelength over a transition by holding the diode temperature fixed (near 22° C. for the R(50) line), and ramp-modulating the injection current from 30 to 150 mA at 8.5 Hz. The DFB laser output is coupled to low-OH silica fibers 310 to minimize transmission losses due to absorption within the fiber, then pitched with a collimating lens 309 into free space for the cell measurements.

Beam splitters 311, 312 split the fiber output and directed one path to the IR wavelength meter 302 for measuring the laser frequency, one path though the solid etalon 308 (free spectral range=2.01 GHz) for monitoring the wavelength variations during laser tuning, and one path through the heated quartz static cell 303 for monitoring CO₂ absorption. A 12-bit digital oscilloscope (not shown) is used for data acquisition.

According to an aspect of the present invention, room-temperature measurements can be made with the heater off and different cells and configurations, including a 20 cm quartz cell with double-pass alignment, and a single-pass 50 cm quartz cell. Unwanted interference fringes due to etaloning in the transmission path are avoided by mounting 0.5° wedged windows at a 3° angle on the cells. Two MKS Instruments Baratron pressure gauges 304, 305 with 100 Torr and 1000 Torr operational ranges, respectively, and accuracies of ±1% are used to monitor the test cell pressure. Note temperature variation along the cell is less than 2% as measured by traversing a type-S thermocouple (not shown) through the furnace.

Selecting the R(50) Transition

FIG. 4 shows the results of pressure broadening at room temperature near 5008 cm⁻¹ for pure CO₂ (T=294K, L=40 cm). At elevated pressures and moderate temperatures, neighboring CO₂ transitions can overlap due to strong collisional broadening. Moreover, the linestrengths and broadening (and thus the overlap) will change with temperature. Therefore, measurements of the fundamental spectroscopic parameters are important for developing accurate sensors.

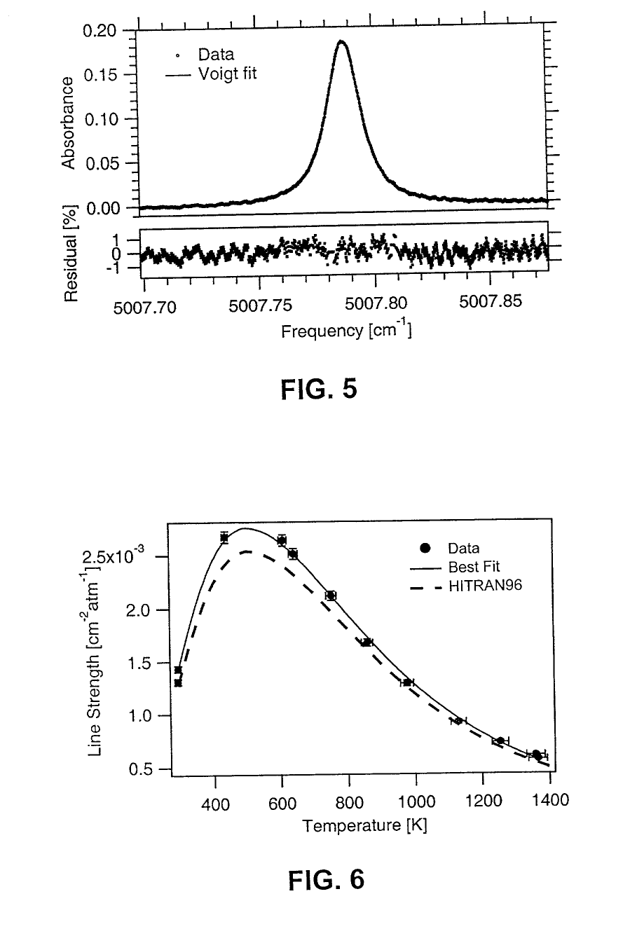

FIG. 5 shows a sample lineshape for static cell measurements of CO₂ absorbance at 5007.787 cm⁻¹ (R(50) transition, P=68.1 Torr, L=40 cm, T=294 K)—a typical static-cell absorption lineshape overlaid with a best-fit Voigt profile. The peak-normalized residual is less than 2% with a standard deviation of 0.5%, yielding a signal-to-noise ratio (SNR) of approximately 200, and has no structure, indicating that the Voigt profile adequately models the absorption lineshape. The high-frequency component in the residual is likely the result of an accidental etalon in the optical path.

The linestrengths at a given temperature are determined by integrating the area of each Voigt fit to the R(50) transition for a range of pressures between 20 and 150 Torr. The integrated absorbance of an individual transition increases linearly with pressure. Thus, the linestrength can be determined by performing a linear fit on the integrated areas at various pressures and using the slope to calculate the linestrength. For example, with CO₂ pressure at T=294 K for the R(50) line at ν₀=5007.787 cm⁻¹, the linestrength for this transition can be inferred from the slope to be 0.001355 cm⁻²atm⁻¹. Since zero pressure corresponds to zero absorbance, the linear fit is constrained to pass through the origin.

The total uncertainty for the individual linestrength measurements is estimated to be approximately 3%, resulting from measurement uncertainties of 1% in the total pressure, and 2% in the area under each Voigt profile. The room-temperature (294 K) linestrength of the R(50) transition is measured to be 0.001355±3×10⁻⁵ cm⁻² atm 1, which is approximately 7% higher than the linestrength of 0.001268 cm⁻²atm⁻¹, previously calculated by L. S. Rothman et al. in “Energy levels, intensities, and linewidths of atmospheric carbon dioxide bands,” 1992, and listed in the HITRAN96 database. This measured linestrength is considered an improvement over the published intensity since the total experimental uncertainty is approximately 3%, compared with 5% for the value in HITRAN96.

The linestrength of R(50) transition is determined for a range of elevated temperatures, as shown in FIG. 6. Using the measured linestrengths at various temperatures and Equation 6, an exponential fit is performed to infer the lower-state energy E″ and to check the accuracy of the transition's quantum assignment (the fit is overlaid in FIG. 6 as a solid line). The lower-state energy is inferred to be 992±5 cm⁻¹, which agrees with the value from HITRAN96 of 994.1913 cm⁻¹ and thereby confirms the line assignment. The measured linestrengths are uniformly 7% higher than the values calculated in HITRAN96, which are overlaid as a dashed line in FIG. 6.

The estimated detectivity of the R(50) transition at a combustion temperature of 1500 K and atmospheric pressure is approximately 200 ppm-m, assuming a noise-equivalent absorbance of 1×10⁻⁴. At a typical exhaust temperature of 500 K, the detectivity is approximately 50 ppm-m. Other transitions in the 2.0 μm band are more suitable for trace-gas detection at cooler temperatures.

The self-broadening coefficient is measured in a fashion analogous to the linestrength. Room-temperature absorption measurements are made between 150 and 500 Torr, a pressure regime in which the collisional width is larger than the Doppler width, and thus collisional width estimates are of higher quality. When performing the Voigt fits, the Doppler width is held constant at the appropriate value for the measurement temperature. The collisional width is extracted from the overall width of the Voigt fit using the calculated Doppler width and the measured Voigt a parameter. The broadening coefficient is determined by performing a linear fit on the measured Lorentzian widths at various pressures and using the slope to calculate the broadening coefficient (see Equation 2). For the R(50) transition, the room-temperature self-broadening coefficient is found to be 2γ_{self}=0.149±0.004 cm⁻¹atm⁻¹, approximately 4% higher than the value listed in HITRAN96 (0.1436 cm⁻¹atm⁻¹) and 1.5% lower than the published calculation of 0.1514 cm⁻¹atm¹ by L. Rosenmann et al., in “Accurate calculated tabulations of IR and Raman CO₂ line broadening by CO₂, H₂O, N₂, O₂ in the 300-2400 K temperature range,” 1988, both of which are within our experimental uncertainty.

Self-broadening coefficients for the R(50) transition are determined for temperatures up to 1400 K, yielding a temperature exponent of N=0.521, which is about 1.5% lower than the calculated value of 0.529 from Rosenmann, id. The total uncertainty for the individual broadening coefficient measurements is estimated to be approximately 4% due to measurement uncertainties of 1% in the total pressure, and 3% in the Lorentzian width extracted from each broadened Voigt profile. Measurements of room-temperature linestrength and self-broadening coefficients are also performed for the neighboring CO₂ transitions between 5007 and 5008.6 cm⁻¹. These spectroscopic parameters are summarized in Table 1 along with the published values for comparison.

TABLE 1

| V₀ | Trans | S_{0,M} | S_{0,H} | 2_{γM} | 2_{γH} | E_{S,M} | E_{S,H} | E_{γ,M} | E_{γ,H} |
|---|---|---|---|---|---|---|---|---|---|
| 5006.979 | R (48) | 0.001892 | 0.001780 | 0.157 | 0.1462 | 3% | 5% | 4% | 20% |
| 5007.363 | R (22) | 0.000143 | 0.000160 | 0.174 | 0.1892 | 3% | 10% | 4% | 10% |
| 5007.787 | R (50) | 0.001355 | 0.001268 | 0.149 | 0.1436 | 3% | 5% | 4% | 20% |
| 5008.566 | R (52) | 0.000901 | 0.000888 | 0.146 | 0.1412 | 3% | 5% | 4% | 20% |
| 5008.580 | R (24) | 0.000148 | 0.000145 | 0.188 | 0.1852 | 3% | 10% | 4% | 10% |

V₀: Linecenter [cm⁻¹] from HITRAN96.
Trans: Transition notation (branch, P or R; and lower-state rotational quantum number, J″).
S_{0,M}: Measured linestrength [cm⁻²atm⁻¹] at T₀ = 294 K.
S_{0,H}: Linestrength from HITRAN96 [cm⁻²atm⁻¹] at T₀ = 294 K.
2_{γM}: Measured self-broadening coefficient [cm⁻¹atm⁻¹] at T₀ = 294 K.
2_{γH}: Self-broadening coefficient from HITRAN96 [cm⁻¹atm⁻¹] at T₀ = 294 K.
E_{S,M}: Uncertainty for the measured room-temperature linestrength.
E_{S,H}: Uncertainty for the room-temperature linestrength from HITRAN96.
E_{γ,M}: Uncertainty for the measured room-temperature broadening coefficient.
E_{γ,H}: Uncertainty for the room-temperature broadening coefficient from HITRAN96.

As can be seen in Table 1, the values listed in HITRAN96 have uncertainties between 5-10% for the linestrengths and 10-20% for the broadening coefficients. Contrastingly, results obtained in accordance with the principles of the present invention exhibit only 3% experimental uncertainty for linestrength and 4% for broadening coefficients, and thus would represent a desirable improvement. Note the discrepancy between the measured and published values is not uniform for the different transitions disclosed herein. Note also that the measured line positions for each of these transitions agreed with HITRAN96 within the precision of the IR wavelength meter (0.01 cm⁻¹).

These spectroscopic results confirm that the R(50) transition offers stronger absorption and superior isolation from high-temperature H₂O spectra in combustion environments than the R(56) line, and thus is particularly selected for the diode laser sensor of the present invention.

Measuring CO₂ in Combustion Environment

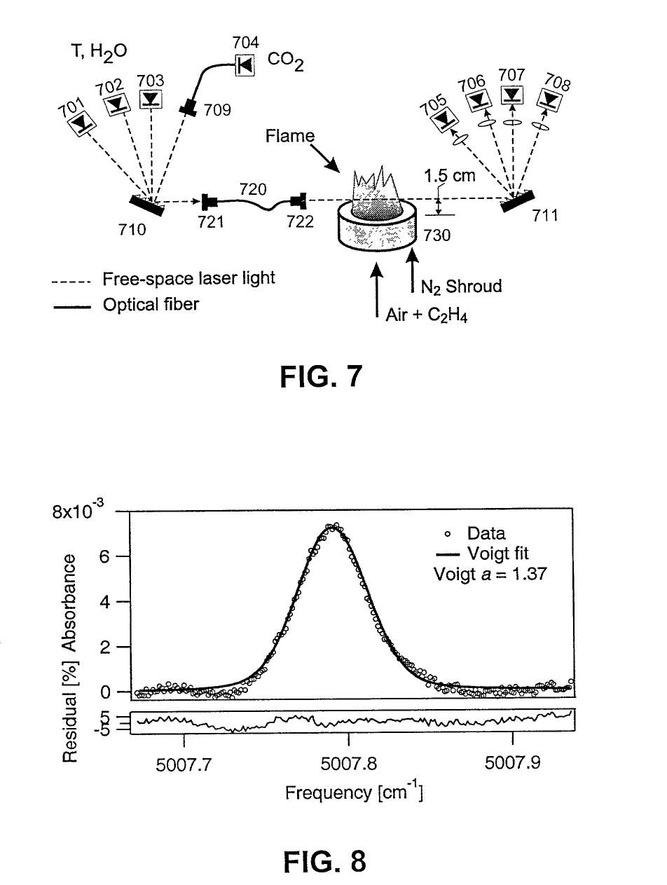

FIG. 7 shows an exemplary setup for the measurements of CO₂ concentration in the combustion region above a flat-flame burner in accordance with the principles of the present invention. As illustrated in FIG. 7, a 6 cm diameter flat-flame burner 730 operates on premixed ethylene and air and uses a shroud flow of N₂ to flatten the horizontal flame sheet, stabilize the flame's outer edges, and minimize the entrainment of ambient air into the combustion region near the burner's surface. The flows of ethylene and air are metered with calibrated rotameters (not shown). Fixing the air flow rate (30.9 L/min) and varying the ethylene flow rate (1.35-3.1 L/min) produce a range of equivalence ratios φ=0.6-1.44 (which is limited by the burner, not the sensor). Uncertainty in the fuel flow rate, and hence the equivalence ratio, is approximately 2%. The temperature is uniform to within 8% variation across the plateau as measured by traversing a type-S thermocouple (not shown) across the combustion region.

The diode laser absorption sensor system of FIG. 7 comprises multiplexed lasers 701-704 operating at 1.343, 1.392, 1.799 and 1.997 μm (ν₁+2ν₂+ν₃ band) respectively. Output beams from lasers 701-704 are combined into one multimode optical fiber 720, e.g., 50 μm core diameter, multimode, low-OH silica, via fiber pitch 709, grating 710 and fiber coupler 721. The combined beam is directed through the combustion region via collimating lens 722 for simultaneous measurements of H₂O, CO₂, and gas temperature along a single optical path (22.8 cm nominal pathlength, four passes) 1.5 cm above the burner surface. The beam is then demultiplexed after the combustion region with a diffraction grating 711, e.g., 830 grooves/mm, 1.25 μm blaze angle, so that the transmitted intensity from each laser could be monitored independently. Standard and extended-wavelength InGaAs detectors 705-708, e.g., 2-mm detector diameter, 300-kHz bandwidth, can be used to record the transmitted beam intensities.

The lasers are wavelength-scanned at 1250 Hz (800 ps per single sweep, 800 points per scan), to minimize beam-steering effects and low frequency (1/f) noise. Detector voltages are sampled at 1 MHz with a 12-bit digital oscilloscope (not shown). Signals due to flame emission are typically less than 3% of the laser intensity and are subtracted from the transmission signals before analysis of the absorption spectra. The spectroscopic details of the water and temperature diagnostic are discussed in “Diode laser absorption sensor for measurements in pulse detonation engines” by S. T. Sanders et al., which is hereby incorporated by reference.

Temperature fluctuations and edge effects in the flame (especially in lean conditions), uncertainty in the temperature measurement (3%), and uncertainty in the linestrengths (3%) are the largest sources of experimental uncertainty for the concentration measurements, producing an overall uncertainty of approximately 10%. Note that in the lean regime, the measured CO₂ concentrations agree within 10% of the equilibrium values, and in the rich regime, within 5%.

FIG. 8 shows a sample data trace of a recorded CO₂ absorption lineshape along with the best Voigt fit and peak-normalized residual for absorption measurement in the combustion region using the R(50) transition (φ=0.79, X_{CO}_{₂}=0.105, T=1690 K, P=1 atm, L=17 cm). Since baselines, corresponding to zero absorbance, are easily determined for this probed CO₂ transition due to its isolation from H₂O interference, single-line Voigt fits are used to determine the integrated area. This isolation and simplicity is an improvement over previous in situ measurements of CO₂ that used the R(56) transition near 1.996 μm. Moreover, the previous CO₂ measurements were recorded with an external cavity diode laser (ECDL) that operated at a tuning rate of 12.5 Hz. The present invention, based on measurements of the isolated R(50) transition recorded at a 1250 Hz tuning rate with a DFB laser, yields accurate CO₂ measurements with an improved detection sensitivity in a shorter measurement time.

In sum, a novel absorption sensor has been developed and demonstrated for fast, accurate, non-intrusive, and sensitive measurements of CO₂ concentration in combustion environments such as high temperature gas flows containing water vapor.

Calculated high-temperature absorption spectra of CO₂ and H₂O are overlaid to find suitable transitions for in situ monitoring, yielding two candidates: the R(50) transition at 5007.787 cm⁻¹ and the R(56) transition at 5010.035 cm⁻¹. The R(50) transition has been specifically chosen based on its superior linestrength and substantial isolation from interfering absorption by high-temperature H₂O, CO, NH₃, N₂O, NO and other species that might be present in combustion and other high-temperature flows. The sensor utilizes a distributed feedback (DFB) diode laser operating at a wavelength substantially near 2.0 μm (i.e., near 1996.89 nm, which is a frequency of 5007.787 cm⁻¹) to interrogate the chosen R(50) transition of the ν₁+2ν₂+ν₃ CO₂ absorption band in the near-infrared.

Measurements of spectroscopic parameters such as the linestrength, self-broadening coefficient and line position have been made for the R(50) transition, and an improved value for the linestrength is disclosed. Specifically, pertinent spectroscopic parameters (S, ν₀, E″, 2γ_{self}) for this transition have been measured and compared with published values, confirming improved values with smaller uncertainties, e.g., room-temperature linestrength with an uncertainty of only 3% and self-bradening coefficient with an uncertainty of only 4%. Furthermore, measurements of CO₂ concentration in the combustion region above a flat-flame burner at atmospheric pressure have been made to verify the fundamental spectroscopic parameters and to demonstrate the capacity and hence the feasibility for in situ monitoring using diode laser sensors near 2.0 μm.

The present invention is useful in numerous industrial applications including combustion systems that produce water vapor and carbon dioxide as flame products such as boilers, waste incinerators, gas turbines, open-air flames, engines, aluminum smelters, etc.; process flows that include carbon dioxide and water vapor, such as for the petrochemical industrials; and indoor air quality monitoring for industrial facilities. For example, CO₂ measurements can be useful in implementing feedback control loops for optimizing combustion or chemical processes, tracking total carbon emissions for compliance-monitoring, estimating fuel inputs for burners such as waste incinerators where the fuel contents vary, or assessing industrial hygiene at sites that use or produce CO₂. It is anticipated that the most common application of the present invention would be in combustion systems where measurements occur at temperatures between 400-2000 K, at pressures at or below 5 atm and in the presence of 5-25% H₂O.

The advantage of laser-based techniques over traditional methods, such as FTIR or electrochemical, is that the measurements can be made quickly (100 Hz measurement rates and higher); in situ (without probes that can perturb the flow or introduce transient delays due to gas transport time) and with species-selectivity and no cross-sensitivity to any other species. That is, the present invention does not require the presence of O₂ or some other species to work, nor is it detrimentally affected by the presence of those species. It is anticipated that a CO₂ monitoring tool based on the principles of the present invention will be useful and/or beneficial in various research and commercial applications.

Although the present invention has been designed, implemented and demonstrated for making measurements in a flame using a fiber-coupled distributed feedback diode laser and a scanned-wavelength direct absorption technique for in situ detection, wherein three other wavelengths are multiplexed and transmitted along the same optical path to measure H₂O concentration and temperature simultaneously using direct absorption, it will be clear to one skilled in the art that various changes, substitutions, and alternations could be made and/or implemented without departing from the principles and the scope of the invention.

For example, different lasers, such as non-fiber-coupled lasers, Fabry-Perot diode laser, distributed Bragg reflector (DBR) lasers, quantum cascade lasers, edge-emitting diode lasers, and vertical cavity surface-emitting lasers (VCSEL's), may be used. Also, temperature can be measured using various techniques including thermocouples and pyrometry. Note that the present invention is not restricted to applications for in situ detection. That is, the measurement approach can be in situ in combustors or in process chambers, or in process and/or sampling lines. Furthermore, the spectroscopic interrogation can occur via scanned- or fixed-wavelength absorption, balanced ratiometric detection (absorption) with Hobb's circuits or otherwise, frequency-modulation (FM) spectroscopy, photothermal deflection, photoacoustic spectroscopy, or any other spectrally-resolved technique.

Accordingly, the scope of the present invention should be determined by the following claims and their legal equivalents.

We claim:

1. A method for non-intrusively measuring carbon dioxide (CO₂) in a high temperature gas flow containing water vapor (H₂O), said method comprising:
providing a laser sensor;
operating said laser sensor at a selective wavelength substantially near 2 μm, selecting the R(50) spectroscopic transition of the ν₁+2ν₂+ν₃ CO₂ absorption band in near-infrared;
utilizing said laser sensor to spectrally interrogate said R(50) spectroscopic transition for sensitive measurements of CO₂, wherein said R(50) spectroscopic transition is substantially isolated from interfering absorption by high temperature species including said water vapor (H₂O) present in said high temperature gas flow.

2. The method of claim 1, wherein said high temperature is characterized to be more than 400 K.

3. The method of claim 1, wherein said interfering high temperature species further comprising CO, NH₃, N₂O, and NO.

4. The method of claim 1, wherein said gas flow is generated by a combustor and said measurements of CO₂ are taken in situ in said combustor.

5. The method of claim 1, wherein said measurements of CO₂ are taken in a process chamber or in a sampling line.

6. The method of claim 1, wherein said laser sensor comprises a fiber-coupled distributed feedback diode laser.

7. The method of claim 1, wherein said laser sensor comprises a non-fiber-coupled laser, a Fabry-Perot (FP) diode laser, a distributed Bragg reflector (DBR) laser, a quantum cascade laser, an edge-emitting diode laser, or a vertical cavity surface-emitting laser (VCSEL).

8. The method of claim 1, wherein said interrogation utilizes a spectrally resolved technique comprising scanned- and fixed-wavelength absorption, balanced ratiometric detection, frequency-modulation (FM) spectroscopy, photothermal deflection, and photoacoustic spectroscopy.

9. A system having a plurality of multiplexed laser sensors operating at a plurality of selective wavelengths for non-intrusively and simultaneously measuring combustion parameters including carbon dioxide (CO₂) along a single optical path in a high temperature gas flow containing water vapor (H₂O), wherein the improvement comprising:
one of said laser sensors operating at a wavelength substantially near 2 μm spectrally interrogates a selective R(50) spectroscopic transition of the ν₁+2ν₂+ν₃ CO₂ absorption band in near-infrared for accurate measurements of CO₂, wherein
said R(50) spectroscopic transition is substantially isolated from interfering absorption by high temperature species present in said high temperature gas flow.

10. The system of claim 9 further comprising:
a multimode optical fiber into which output beams from said multiplexed lasers are combined;
a collimating lens for directing said combined output beams through said high temperature gas flow; and
a diffraction grating for demultiplexing said combined output beams so that transmitted intensity from each of said plurality of laser sensors as well as said combustion parameters can be simultaneously independently monitored along said single optical path by a plurality of detectors.

11. The system of claim 10, wherein said combustion parameters further comprise H₂O and temperature.

12. The system of claim 10, wherein said plurality of detectors comprise extended wavelength response detectors.

13. The system of claim 9, wherein said high temperature is characterized to be more than 400 K.

14. The system of claim 9, wherein said interfering high temperature species comprises said water vapor.

15. The system of claim 14, wherein said interfering high temperature species further comprises CO, NH₃, N₂O, and NO.

16. The system of claim 9, wherein said gas flow is generated by a combustor and said measurements of CO₂ are taken in situ in said combustor.

17. The system of claim 9, wherein said measurements of CO₂ are taken in a process chamber or in a sampling line.

18. The system of claim 9, wherein said plurality of laser sensors are characterized as fiber-coupled distributed feedback diode lasers.

19. The system of claim 9, wherein said plurality of laser sensors are characterized as non-fiber-coupled lasers, Fabry-Perot (FP) diode lasers, distributed Bragg reflector (DBR) lasers, quantum cascade lasers, edge-emitting diode lasers, or vertical cavity surface-emitting lasers (VCSEL).

20. The system of claim 9, wherein said interrogation utilizes a spectrally resolved technique comprising scanned- and fixed-wavelength absorption, balanced ratiometric detection, frequency-modulation (FM) spectroscopy, photothermal deflection, and photoacoustic spectroscopy.
